(19) United States
(12) Patent Application Publication
(10) Pub. No.: US 2012/0267488 A1
(43) Pub. Date: Oct. 25, 2012

(54) ADJUSTABLE SUPPORT DEVICE WITH MULTIPLE ROLLING ELEMENTS

(75) Inventors: George Fanourgiakis, Foster City, CA (US); Lawrence J. Brucia, San Anselmo, CA (US)

(73) Assignees: Lawrence J. Brucia, San Anselmo, CA (US); George Fanourgiakis, Foster City, CA (US)

(21) Appl. No.: 13/092,064

(22) Filed: Apr. 21, 2011

(51) Int. Cl. F16M 11/32; B23P 11/00; F16M 11/28

(52) U.S. Cl. 248/157; 29/428

(57) ABSTRACT

Adjustable support devices with multiple rolling elements are disclosed. An adjustable support device includes a base that includes a plurality of rolling element receiving cavities, a plurality of rolling elements that interface with the rolling element receiving cavities, and an external sleeve coupled to the base for adjustable vertical positioning of the external sleeve relative to the base. Each of the rolling element receiving cavities is positioned and oriented to interface with a rolling element disposed between the base and the support surface. The external sleeve can be placed in a first vertical position relative to the base where the external sleeve contacts the support surface. And the external sleeve can be placed in a second vertical position relative to the base where the external sleeve does not contact the support surface.

### BACKGROUND

The present invention relates generally to devices used to support an item relative to a support surface, and more particularly to a height adjustable support device with multiple rolling elements, and related system and methods.

Various devices have used to reduce the effort required to move an object along a support surface. For example, casters are non-actuated wheels that are mounted to the bottom of a larger object to reduce the effort necessary to move the object. Casters are found in numerous applications, including shopping carts, office chairs, and material handling equipment. High capacity, heavy duty casters are used in many industrial applications, such as platform trucks and carts. Generally, casters operate on smooth and flat surfaces.

Casters do, however, suffer from a number of problems. One disadvantage of casters is shimmy or caster flutter, where a caster rapidly swings side-to-side. Caster flutter may cause the supported object to move in an unwanted direction. Casters may also be easily obstructed by an item such as a power chord or an irregularity of the support surface. And many casters lack provisions for leveling of the supported object and preventing unwanted movement of the supported object along the support surface. Accordingly, improved devices for supporting an object relative to a support surface would be beneficial, particularly devices that do not suffer from the above-identified issues with casters.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Height adjustable support devices for supporting an object relative to a support surface are disclosed, as well as related systems and methods. The disclosed support devices can include multiple rolling elements and can include a height adjustable outer sleeve. The multiple rolling elements increase the load capacity of the support device and increase the tolerance of the support device to irregularities of the support surface. The height adjustable outer sleeve provides for leveling of the supported object and can be positioned to keep obstructions such as power cords from coming into contact with the rolling elements. The height adjustable outer sleeve can also serve to prevent unwanted movement of the supported object along the support surface by lifting the rolling elements out of contact with the support surface and thereby increasing the frictional restraint between the support device and the support surface.

Thus, in one aspect, an adjustable support device is provided. The device includes a base that includes a plurality of rolling element receiving cavities, a plurality of rolling elements that interface with the rolling element receiving cavities, and an external sleeve coupled to the base for adjustable vertical positioning of the external sleeve relative to the base. Each of the rolling element receiving cavities is positioned and oriented to interface with a rolling element disposed between the base and the support surface. The external sleeve can be placed in a first vertical position relative to the base where the external sleeve contacts the support surface. And the external sleeve can be placed in a second vertical position relative to the base where the external sleeve does not contact the support surface.

Suitably shaped rolling elements can be used. For example, the rolling elements can include one or more rolling elements having a spherical shape. And the rolling elements can include one or more rolling elements having a cylindrical shape.

The base can be configured to be rotatable relative to the supported item. For example, the base can include a top portion that remains fixed relative to the supported item when the adjustable support device is attached to a supported item, and a bottom portion that is rotatable relative to the top portion. In many embodiments, the base includes a thrust-bearing coupled between the top portion and the bottom portion. Such an articulated base can be used to orient rolling elements having a cylindrical shape to move along a desired direction of travel.

The base can include a feature for attaching the base to the supported item. For example, the base can include a threaded stud for attaching the base to the supported item. In many embodiments, the threaded stud has a left-handed thread. By using a left-handed thread on the threaded stud, loosening of the attachment between the base and the supported item may be prevented during adjustment of the position of the external sleeve.

The external sleeve can be coupled to the base via a threaded interface. For example, the base can include an externally-threaded portion and the external sleeve can include an internally-threaded portion to interface with the externally-threaded portion of the base so that rotation of the external sleeve relative to the base adjusts the vertical position of the external sleeve relative to the base. The external sleeve can include one or more external wrenching features shaped to interface with a tool used to rotate the external sleeve relative to the base. For example, the one or more external wrenching features can include an opposing pair of parallel flat surfaces. And the one or more external wrenching features can include a plurality of opposing pairs of parallel flat surfaces. Any suitable external wrenching features can be employed.

The base can include two or more of the rolling element receiving receptacles. For example, the base can include three or more, four or more, six or more, or nine or more, rolling element receiving receptacles.

The adjustable support device can include a feature to retain the rolling elements in the rolling element receiving receptacles. For example, the device can include a retention plate attachable to the base and configured to retain the rolling elements in the rolling element receiving receptacles. The retention plate can have a plurality of openings with each of the openings configured to accommodate a portion of one of the rolling elements such that the rolling element partially protrudes below the retention plate. And the device can include one or more removable fasteners to attach the retention plate to the base. The retention plate can include one or more internally-threaded protruding portions that are received within corresponding cavities in the base. Each of the internally-threaded protruding portions can receive one of the removable fasteners.

In many embodiments, the external sleeve can be positioned such that a substantially uniform gap between the external sleeve and the support surface exists and is sufficiently small enough to block objects such as cords from obstructing the rolling elements. For example, in many embodiments, the external sleeve can be positioned to result in a substantially uniform gap of less than 10 mm between the external surface and the support surface. And in many embodiments, the external sleeve can be positioned to result in a substantially uniform gap of less than 5 mm between the external surface and the support surface. And in many embodiments, the external sleeve can be positioned to result in a substantially uniform gap of less than 3 mm between the external surface and the support surface.

In another aspect, a system is provided for supporting an item relative to a support surface. The system includes three or more adjustable support devices. Each of the support devices includes a base that includes a plurality of rolling element receiving cavities, a plurality of rolling elements that interface with the rolling element receiving cavities, and an external sleeve coupled to the base for adjustable vertical positioning of the external sleeve relative to the base. Each of the rolling element receiving cavities is positioned and oriented to interface with a rolling element disposed between the base and the support surface. The external sleeve can be placed in a first vertical position relative to the base where the external sleeve contacts the support surface. And the external sleeve can be placed in a second vertical position relative to the base where the external sleeve does not contact the support surface.

In another aspect, a method is provided for supporting an item relative to a support surface. The method includes receiving a base attached to the supported item so as to be disposed between the supported item and the support surface, the base including a plurality of rolling element receiving receptacles. The method further includes receiving each of a plurality of rolling elements interfaced with one of the rolling element receiving receptacles. The rolling elements are retained relative to the base. The method further includes receiving an external sleeve that is coupled to the base for adjustable vertical positioning of the external sleeve relative to the base. The external sleeve is adjusted relative to the base so that the external sleeve does not contact the support surface and the supported item is supported relative to the support surface via the rolling elements. And the external sleeve is adjusted relative to the base so that the external sleeve contacts the support surface and the supported item is supported relative to the support surface via the contact between the external sleeve and the support surface. The method can further include adjusting the external sleeve relative to the base so that a substantially uniform gap of less than 5 mm is formed between the external sleeve and the support surface.

For a fuller understanding of the nature and advantages of the present invention, reference should be made to the ensuing detailed description and accompanying drawings.

### BRIEF DESCRIPTION OF THE DRAWINGS

FIG. 1 is a perspective view illustrating an adjustable support device, in accordance with many embodiments, attached to the leg of a supported item.

FIG. 2 is an exploded perspective view illustrating the adjustable support device of FIG. 1.

FIG. 3 is a cross-sectional view of the adjustable support device of FIG. 1 with an external sleeve positioned so that the supported item is supported via rolling elements of the support device.

FIG. 4 is a cross-sectional view of the adjustable support device of FIG. 1 with the external sleeve positioned to contact a support surface so as to support the supported item.

FIG. 5 is a side view of the adjustable support device of FIG. 1 with the external sleeve positioned so that a small gap exists between the external sleeve and the support surface so that the external sleeve functions as a guard to prevent items such as cords from obstructing the rolling elements, in accordance with many embodiments.

FIG. 6 is a perspective view illustrating an adjustable external sleeve of an adjustable support device, in accordance with many embodiments.

FIG. 7 is a perspective view illustrating the attachment of a retention plate to a base of an adjustable support device, in accordance with many embodiments.

FIG. 8 is a cross-sectional view illustrating the adjustable support device of FIG. 7 and further illustrating a set screw used to secure the position of an adjustable external sleeve relative to a base, in accordance with many embodiments.

FIG. 9 is a perspective view illustrating a retention plate having integral protruding internally-threaded portions used to secure the retention plate to a base, in accordance with many embodiments.

FIG. 10 is an exploded-perspective view illustrating an adjustable support device, in accordance with many embodiments, having cylindrical rolling elements, the adjustable support device being rotatable relative to a supported item to orient the cylindrical rolling elements for movement along a desired direction of travel.

FIG. 11 is a side view illustrating the adjustable support device of FIG. 10.

FIG. 12 is a bottom view illustrating the adjustable support device of FIG. 10.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention can be practiced without the specific details. Furthermore, well-known features may be omitted or simplified in order not to obscure the embodiment being described.

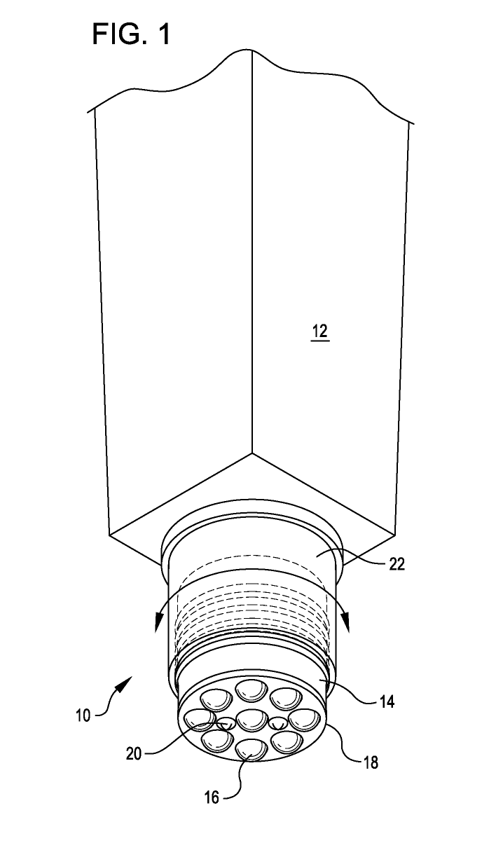

Referring now to the drawings, in which like reference numerals represent like parts throughout the several views, FIG. 1 shows an adjustable support device 10 attached to supported item 12. The support device 10 includes a base 14, a plurality of rolling elements 16 that are retained within rolling element receiving cavities of the base by a retention plate 18. The base 14 has a generally cylindrical shape. Each of the rolling element receiving cavities is shaped and sized to permit the rolling element to rotate in the rolling element receiving cavity. The retention plate 18 is secured to the base 14 by removable fasteners 20. The retention plate includes apertures that are shaped, sized, and positioned to retain each of the rolling elements 16 while allowing a portion (e.g., a ⅓ diametrical portion) of each of the rolling elements to protrude below the bottom surface of the retention plate 18. An adjustable external sleeve 22 has a generally cylindrical body and is coupled with the base 14 so that the vertical position of the external sleeve 22 relative to the base 14 can be adjusted. While the external sleeve 22 of the present embodiment has a cylindrical external shape, other suitable configurations can be used, for example, polygonal external shapes can be used. In many embodiments, the base 14 includes an externally-threaded portion that interfaces with an internally-threaded portion of the external sleeve 22 so that rotation of the external sleeve relative to the base results in vertical movement of the external sleeve relative to the base. In many embodiments, the external sleeve can be positioned out of contact with a support surface so that the rolling elements contact the support surface and can be positioned to contact the support surface and adjusted to aid in leveling the supported item. When the external sleeve is adjusted to contact the support surface it may also help prevent inadvertent movement of the supported item along the support surface by increasing the amount of sliding friction present.

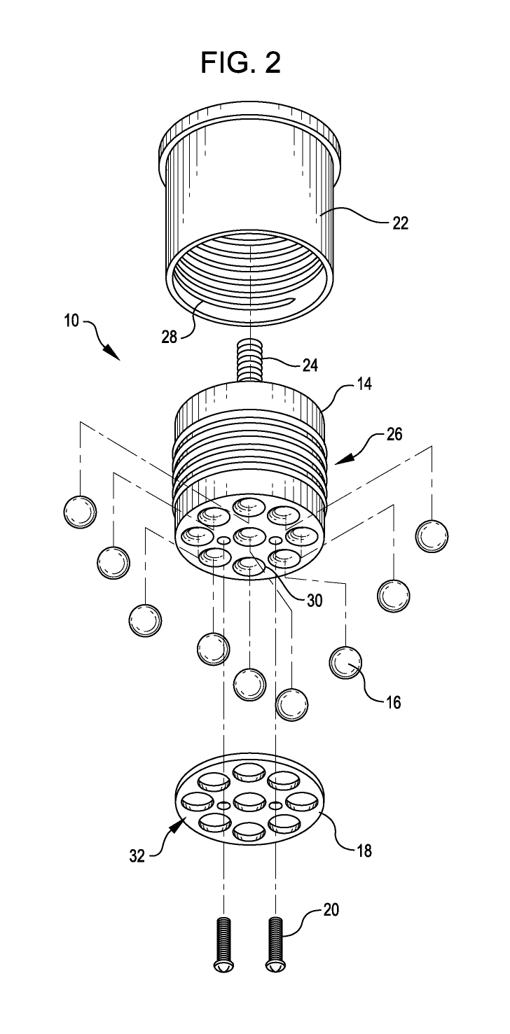

FIG. 2 is an exploded perspective view of the adjustable support device 10. The base includes a threaded stud 24 for attaching the base 14 to a supported item (e.g., to a leg of a supported item). In many embodiments, the threaded stud 24 has a left-handed thread so that when the external sleeve 22 is adjusted downward relative to the base the threaded stud does not unscrew from the supported item. The threaded stud 24 can have any suitable configuration to interface with the supported item. For example, when the base is attached to a wooden leg of the supported item, the threaded stud can include a self tapping thread (e.g., wood screw thread, lag bolt thread). And the supported item can include an internally-threaded receptacle or nut that receives the threaded stud.

The base 14 includes an externally-threaded portion 26 that interfaces with an internally-threaded portion 28 of the external sleeve 22. Any suitable configuration of thread can be used. For example, a fine thread with a pitch of 1.25 mm can be used.

The base 14 has nine rolling element receiving receptacles 30 that are shaped and sized to accommodate a corresponding nine rolling elements 16. For example, each of the rolling element receiving cavities 30 can be spherically shaped (e.g., a half sphere) and sized to accommodate a spherically-shaped rolling element 16 so as to permit the rolling element to rotate relative to the rolling element receiving cavity. Any suitable diameter of spherically-shaped rolling element can be used (e.g., 3/16 inch). While the adjustable support device 10 is shown with nine rolling element receiving receptacles, any suitable number of rolling element receiving receptacles and associated rolling elements can be used. For example, two, three, four or more, six or more, and more than nine rolling element receiving receptacles and associated rolling elements can also be used.

The retention plate 18 is attached to the base 14 by the two removable fasteners 20 that engage internally-threaded holes in the base, thereby retaining the rolling elements in the rolling element receiving receptacles. Other suitable ways of attaching the retention plate to the base case can also be used. And other suitable ways of retaining the rolling elements can also be used.

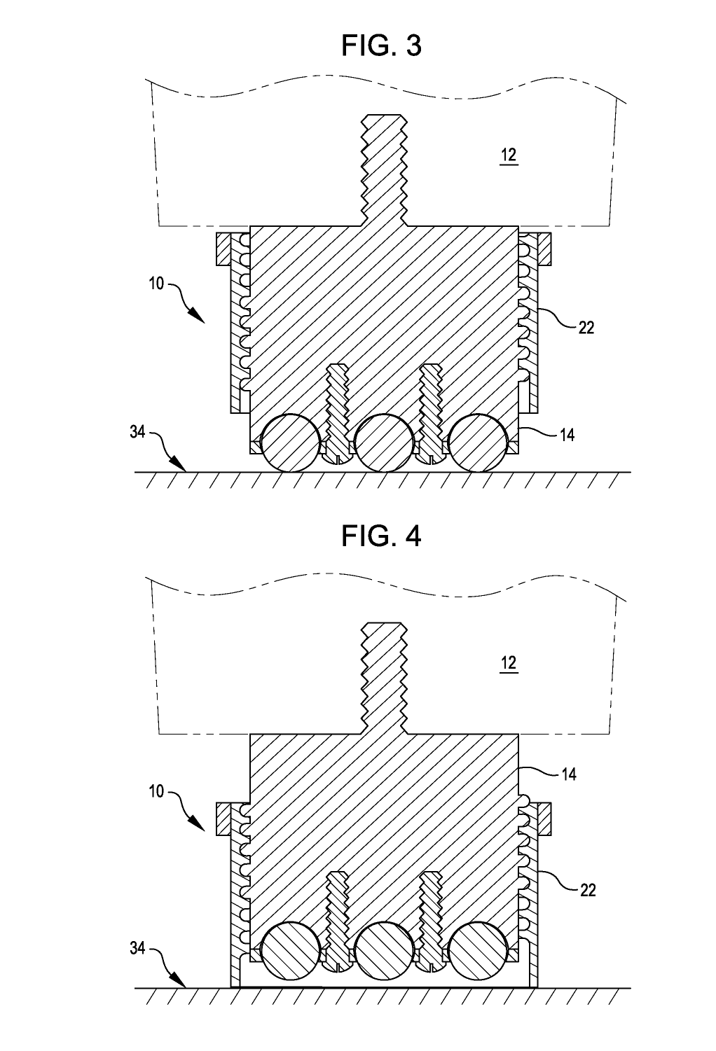

The rolling element receiving cavities and the retention plate are shaped and sized to accommodate and retain the rolling elements. With the retention plate removed, the rolling element receiving cavities are shaped and sized to receive the rolling elements. The retention plate has a circular flat body with apertures 32 having side walls shaped to accommodate and retain the rolling elements. As shown in both FIG. 3 and FIG. 4, the side walls of the apertures 32 are tapered or contoured to retain the rolling elements within the rolling element receiving cavities.

FIG. 3 and FIG. 4 also illustrate possible positions of the adjustable sleeve 22 relative to the base 14. FIG. 3 shows the adjustable sleeve 22 positioned above a support surface 34 so that the rolling elements contact the support surface, and thereby provides rolling elements between the support surface and the supported item 12 to reduce the effort necessary to move the supported item along the support surface. And FIG. 4 shows the adjustable sleeve 22 positioned to contact the support surface 34 so that the rolling elements are elevated above the support surface, thereby providing a way to level the supported item 12 and to restrict movement of the supported item along the supported surface by providing a non-rolling contact between the support device 10 and the support surface 34.

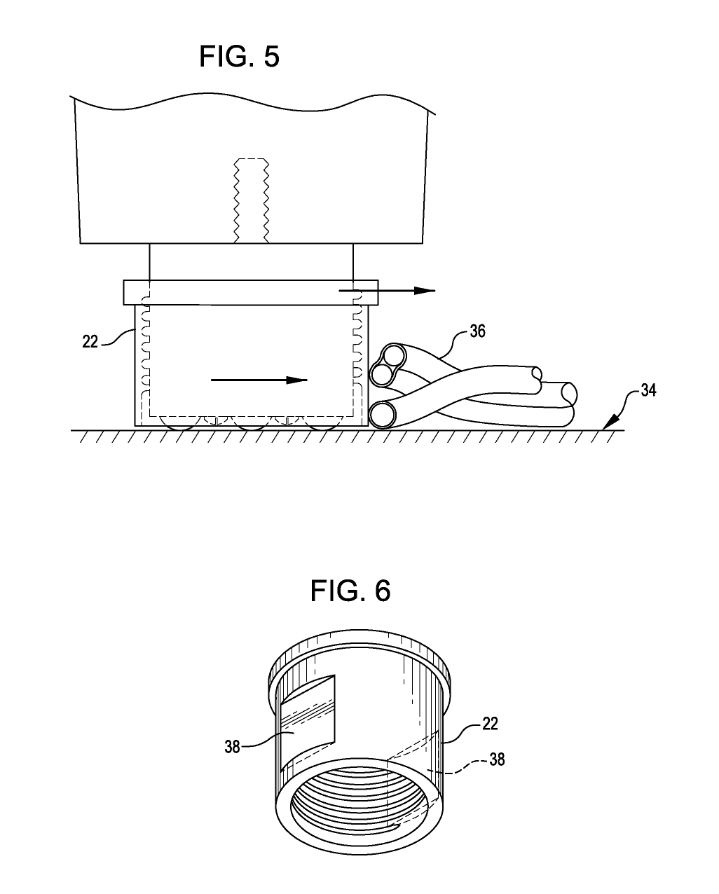

FIG. 5 shows the adjustable sleeve 22 positioned so that a relatively small gap exists between the adjustable sleeve and the support surface 34. As illustrated, this configuration may be useful in preventing possible obstructions such as electrical cords 36 from contacting the rolling elements and thereby helping to prevent obstruction of the rolling elements.

FIG. 6 shows a perspective view of an adjustable external sleeve 22 that includes external wrenching features shaped to interface with a tool used to rotate the external sleeve 22 relative to the base. The external wrenching features are a pair of opposed parallel surfaces 38 that can be engaged by a tools such an open-ended wrench to rotate the external sleeve relative to the base, thereby adjusting the vertical position of the external sleeve relative to the base. While a single pair of opposed parallel surfaces are shown, any other suitable wrenching features can be used. For example, any suitable number of opposing pairs of parallel flat surfaces can be used.

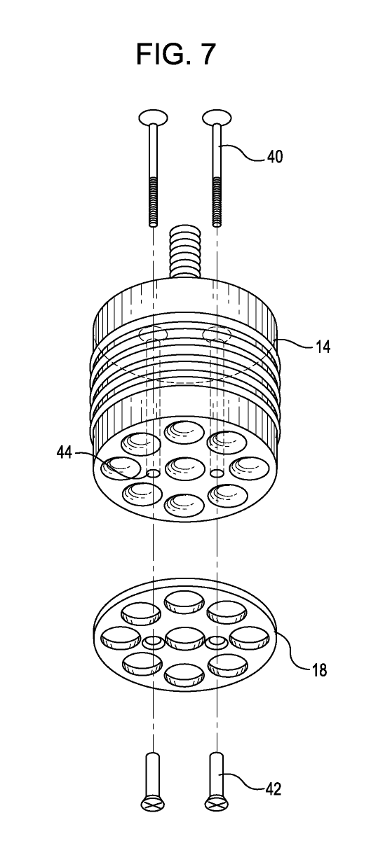

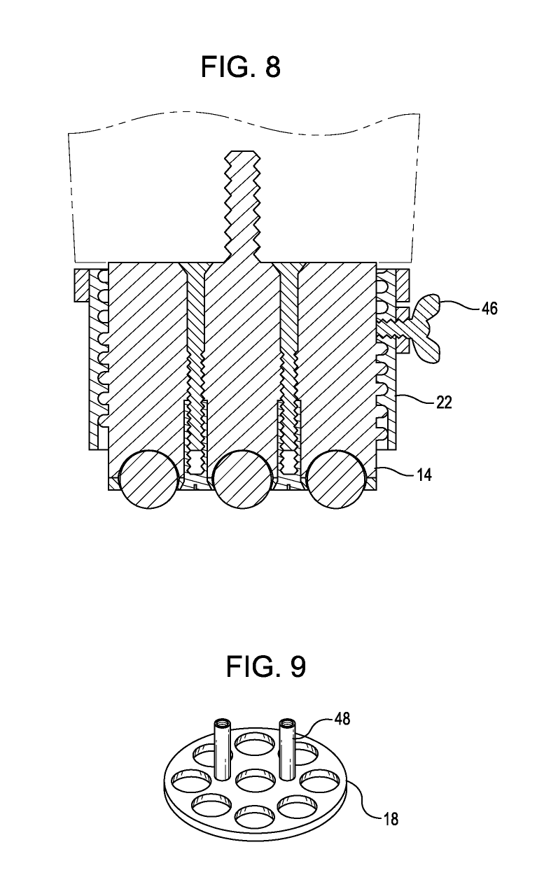

FIG. 7 and FIG. 8 show another way of attaching the retention plate 18 to the base 14. Two externally-threaded recessed head bolts 40 engage mating recessed head internally-threaded mating elements 42, thereby providing a flush installation where the attachment fasteners do not protrude below the retention plate 18. The base 14 includes recesses 44 sized and shaped to accommodate the bolts 40 and the mating elements 42.

FIG. 8 further illustrates a retention screw 46 operable to prevent inadvertent rotation of the adjustable sleeve 22 relative to the base 14, thereby preventing inadvertent vertical movement of the adjustable sleeve relative to the base. FIG. 9 shows a retention plate 18 with integral protruding portions 48 that are internally-threaded to receive and couple with the bolts 40.

The various components of the adjustable support device 10 can be fabricated from suitable materials. For example, the base 14 and the adjustable sleeve 22 can be made from a suitable material, such any suitable alloy of aluminum or stainless steel with any suitable heat treatment. Alternatively, the base and the adjustable sleeve can be made from any suitable titanium, copper, galvanized metal, plastic, and nylon. The support balls 16 can be made from, for example, nylon, stainless steel, steel, polyurethane, plastic, carbon fiber, ceramic, Teflon, and copper.

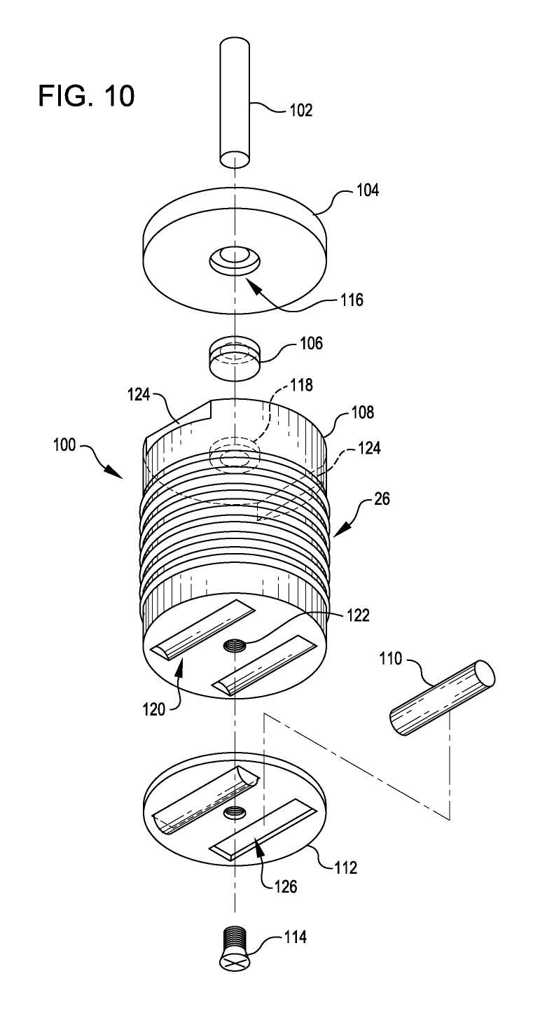

FIG. 10 is an exploded perspective view of an adjustable support device 100 that has cylindrically-shaped rolling elements and that is rotatable relative to the supported item so that the cylindrically-shaped rolling elements can be oriented to move along a desire direction. The adjustable support device 100 includes a mounting pin 102, a base top portion 104, a thrust bearing 106, a base bottom portion 108, cylindrically-shaped rolling elements 110, a retention plate 112, and a retention plate fastener 114.

The mounting pin 102 has a cylindrical outer surface that interfaces with the inside diameter of the thrust bearing 106. The mounting pin 102 can be appropriately coupled with the supported item and/or the base bottom portion 108. For example, the mounting pin 102 can include an upper threaded portion for attaching the mounting pin 102 with the supported item such that the mounting pin 102 extends vertically downward from the supported item. As another example, the mounting pin can include a lower threaded portion for attaching the mounting pin 102 with the base bottom portion 108 such that the mounting pin 102 extends vertically upward from the base bottom portion 108.

The base top portion 104 interfaces with the supported item. The base top portion 104 includes an aperture through which the mounting pin 102 extends and a receptacle 116 shaped to receive and support the top portion of the thrust bearing 106. The base top portion 104 can serve as a non-rotating part of the adjustable support device 100 relative to the supported item.

The thrust bearing 106 interfaces with the receptacle 116 in the base top portion and a similar receptacle 118 in the base bottom portion 108. The portion of the weight of the supported item that is supported by the adjustable support device 100 is transferred from the base top portion 104 to the base bottom portion 108 through the thrust bearing 106. The thrust bearing 106 also provides for relative rotation between the base top portion 104 and the base bottom portion 108.

The base bottom portion 108 can include features similar to features of the base portion 14 of the adjustable support device 10. The base bottom portion 108 includes an externally-threaded portion 26, rolling element receiving cavities 120, and the receptacle 118 shaped to receive and support the bottom portion of the thrust bearing 106. The base bottom portion 108 includes a threaded hole 122 used to secure the retention plate 112 to the base bottom portion 108 via the retention plate fastener 114. While only one threaded hole 122 and a corresponding one retention plate fastener 114 is shown, any suitable approach for attaching the retention plate 112 to the base bottom portion 108 can be used. For example, the attachment approaches used to attach the retention plate 18 to the base 14 in the adjustable support device 10 can also be used in the adjustable support device 100. Each of the rolling element receiving cavities 120 is shaped to accommodate one of the cylindrically-shaped rolling elements 110 and to allow the cylindrically-shaped rolling elements 110 to rotate within the rolling element receiving cavities 120 during movement of the supported item along the support surface. While the adjustable support device 100 is shown with two cylindrically-shaped rolling elements 110, any suitable number and combination of rolling element types can be used. For example, one or more rolling elements having a spherical shape can be used in conjunction with one or more cylindrically-shaped rolling elements 110. Each of the rolling element receiving cavities 120 can have a half-cylindrical configuration. The base bottom portion 108 includes opposing parallel surfaces 124, which can be used as external wrenching features that can interface with a tool used to rotate the base bottom portion 108 relative to the supported item to orient the cylindrically-shaped rolling elements 110 for movement of the supported item in a desired direction along the support surface. In general, any other suitable external wrenching feature(s) can be used.

The retention plate 112 includes apertures 126 that are shaped, sized, and positioned to retain each of the cylindrically-shaped rolling elements 110 within the rolling element receiving cavities 120 while allowing a portion (e.g., ⅓ diametrical portion) of each of the cylindrically-shaped rolling elements 110 to protrude below the bottom surface of the retention plate 112. Each of the apertures 126 can have sloped side walls shaped to accommodate the cylindrical outer surface of the cylindrically-shaped rolling element 110.

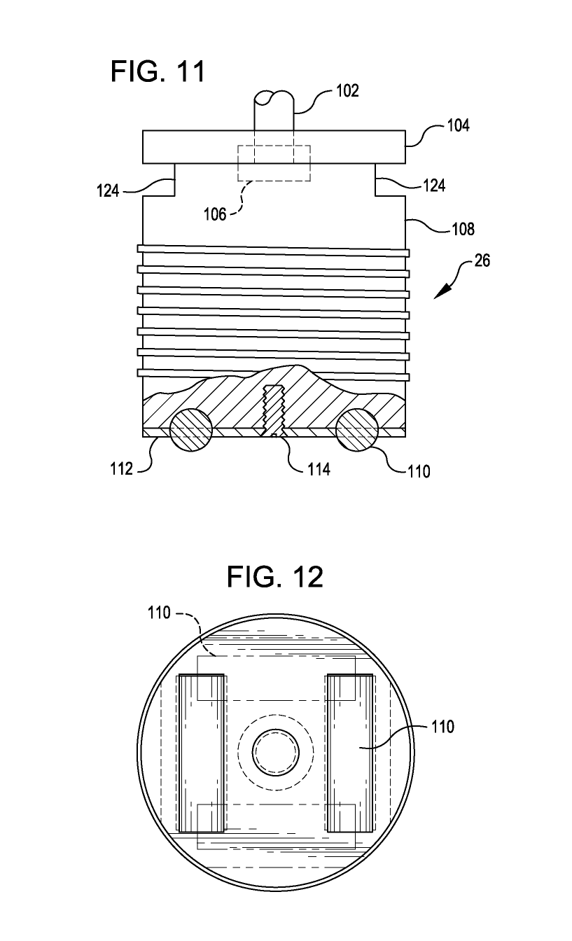

FIG. 11 and FIG. 12 further illustrate the adjustable support device 100. FIG. 11 is a side view of the adjustable support device 100. And FIG. 12 is a bottom view of the adjustable support device 100 and shows in phantom an alternate orientation of the cylindrically-shaped rolling elements 110 that can be obtained by rotating the base bottom portion 108 relative to the supported item.

The various components of the adjustable support device 100 can be fabricated from any suitable material, for example, from the materials discussed above with respect to corresponding components of the adjustable support device 10. Similarly, the various components of the adjustable support device 100 can be suitably sized and configured, for example, sized and configured similar to the adjustable support device 10.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An adjustable support device comprising:
a base attachable to a supported item so as to be disposed between the supported item and a support surface, the base including a plurality of rolling element receiving receptacles, each of the rolling element receiving receptacles positioned and oriented to interface with a rolling element disposed between the base and the support surface;
a plurality of rolling elements, each of the rolling elements interfacing with one of the rolling element receiving receptacles; and
an external sleeve coupled to the base for adjustable vertical positioning of the external sleeve relative to the base, wherein the external sleeve can be placed in a first vertical position relative to the base where the external sleeve contacts the support surface and can be placed in a second vertical position relative to the base where the external sleeve does not contact the support surface.

2. The adjustable support device of claim 1, wherein the rolling elements comprise a rolling element having a spherical shape.

3. The adjustable support device of claim 1, wherein the rolling elements comprise a rolling element having a cylindrical shape.

4. The adjustable support device of claim 3, wherein the base comprises a top portion and a bottom portion that is rotatable relative to the top portion.

5. The adjustable support device of claim 4, wherein the base comprises a thrust bearing coupled between the top and bottom portions.

6. The adjustable support device of claim 1, wherein the base includes a threaded stud having a left-handed thread for attaching the base to the supported item.

7. The adjustable support device of claim 1, wherein:
the base includes an externally-threaded portion; and
the external sleeve includes an internally-threaded portion configured to interface with the externally-threaded portion of the base so that rotation of the external sleeve relative to the base adjusts the vertical position of the external sleeve relative to the base.

8. The adjustable support device of claim 7, wherein the external sleeve includes one or more external wrenching features shaped to interface with a tool used to rotate the external sleeve relative to the base.

9. The adjustable support device of claim 8, wherein the one or more external wrenching features includes an opposing pair of parallel flat surfaces.

10. The adjustable support device of claim 9, wherein the one or more external wrenching features includes a plurality of opposing pairs of parallel flat surfaces.

11. The adjustable support device of claim 1, wherein the base includes three or more of the rolling element receiving receptacles.

12. The adjustable support device of claim 11, wherein the base includes six or more of the rolling element receiving receptacles.

13. The adjustable support device of claim 1, further comprising a retention plate attachable to the base and configured to retain the plurality of rolling elements in the rolling element receiving receptacles, the retention plate having a plurality of openings, each opening configured to accommodate a portion of one of the rolling elements such that the rolling element partially protrudes below the retention plate.

14. The adjustable support device of claim 13, further comprising one or more removable fasteners to attach the retention plate to the base.

15. The adjustable support device of claim 14, wherein the retention plate includes one or more internally-threaded protruding portions that are received within corresponding one or more cavities in the base, each of the internally-threaded protruding portions receiving one of the one or more removable fasteners.

16. The adjustable support device of claim 1, wherein the second vertical position of the external sleeve relative to the base results in a substantially uniform gap of less than 10 mm between the external sleeve and the support surface.

17. The adjustable support device of claim 16, wherein the second vertical position of the external sleeve relative to the base results in a substantially uniform gap of less than 5 mm between the external sleeve and the support surface.

18. A system for supporting an item relative to a support surface, the system comprising three or more adjustable support devices, each adjustable support device including:
a base attachable to a supported item so as to be disposed between the supported item and a support surface, the base including a plurality of rolling element receiving receptacles, each of the rolling element receiving receptacles positioned and oriented to interface with a rolling element disposed between the base and the support surface;
a plurality of rolling elements, each of the rolling elements interfacing with one of the rolling element receiving receptacles; and
an external sleeve coupled to the base for adjustable vertical positioning of the external sleeve relative to the base, wherein the external sleeve can be placed in a first vertical position relative to the base where the external sleeve contacts the support surface and can be placed in a second vertical position relative to the base where the external sleeve does not contact the support surface.

19. A method for supporting an item relative to a support surface, the method comprising:
receiving a base attached to the supported item so as to be disposed between the supported item and the support surface, the base including a plurality of rolling element receiving receptacles;
receiving each of a plurality of rolling elements interfaced with one of the rolling element receiving receptacles;
retaining the rolling elements relative to the base;
receiving an external sleeve coupled to the base for adjustable vertical positioning of the external sleeve relative to the base;
adjusting the external sleeve relative to the base so that the external sleeve does not contact the support surface and the supported item is supported relative to the support surface via the rolling elements; and
adjusting the external sleeve relative to the base so that the external sleeve contacts the support surface and the supported item is supported relative to the support surface via the contact between the external sleeve and the support surface.

20. The method of claim 19, further comprising adjusting the external sleeve relative to the base so that a substantially uniform gap of less than 5 mm is formed between the external sleeve and the support surface.
